(19) United States
(12) Patent Application Publication
(10) Pub. No.: US 2026/0197083 A1
(43) Pub. Date: Jul. 9, 2026

(54) OPTICAL TRANSMISSION SYSTEM AND ADJUSTMENT METHOD

(71) Applicant: NTT, Inc., Tokyo (JP)

(72) Inventors: Jin UCHIYAMA, Musashino-shi (JP); Ryo KOMA, Musashino-shi (JP); Kazutaka HARA, Musashino-shi (JP); Takuya KANAI, Musashino-shi (JP); Yumiko SENOO, Musashino-shi (JP); Ryo IGARASHI, Musashino-shi (JP); Junichi KANI, Musashino-shi (JP)

(73) Assignee: NTT, Inc., Tokyo (JP)

(21) Appl. No.: 18/863,586

(22) PCT Filed: May 17, 2022
(86) PCT No.: PCT/JP2022/020493

§ 371 Date: Nov. 6, 2024

(51) Int. Cl. H04B 10/2513; H04Q 11/00

(52) U.S. Cl. CPC H04B 10/2513; H04Q 11/0005; H04Q 2011/0041

(57) ABSTRACT

An optical transmission system including: an optical switch that includes a plurality of ports, outputs an optical signal input from any one of the ports from a different one of the ports, and acquires transmission path information on the basis of the optical signal input to the port; a plurality of dispersion compensation units that compensate for quality of the optical signal output from the optical switch and input the optical signal with the compensated quality to the optical switch; an α parameter measurement unit that acquires an α parameter indicating a chirp level on the basis of the optical signal with the compensated quality; and a control unit that performs correction of the α parameter or adjustment of a dispersion compensation amount in a case where a condition indicating that a problem that is attributable to the α parameter has occurred is satisfied on the basis of a cumulative wavelength dispersion amount or a transmission distance obtained on the basis of the transmission path information and the α parameter.

### TECHNICAL FIELD

The present invention relates to an optical transmission system and an adjustment method.

### BACKGROUND ART

Broadband has now become widespread, and new network services such as automatic driving, remote medical care, and further, cyber-physical services, and smart factories have been created in recent years. Among these, automatic driving and remote medical care services require good real-time control and require a network with a low latency (see Non Patent Literature 1, for example).

In a cyber-physical system that collects a variety of feature amounts from a sensor device such as a sensor that is present in the real world, processes and analyzes them in a cyber space, and provides feedback to the real world, there is a use case in which a skilled engineer remotely monitors a facility by using an ultra-high-reality movie and performs control as needed, and for this, a transmission platform with a large capacity in addition to low latency is needed (see Non Patent Literature 2, for example).

In addition, there is a need to collect and analyze data by using a variety of sensor devices in a smart factory in order to enhance process efficiency and reduce operation costs. Therefore, a network that does not depend on a protocol of a device to be connected thereto is required. In order to reduce capital investment and running costs in such a use case and provide a stable service in consideration of scalability as well, an increase in power consumption with scale expansion has been a major problem. As such, future networks will be required to have not only larger capacity, but also be protocol independent, with even lower latency, and lower power consumption.

As a creation of a new service to meet such requirements, an innovative optical and wireless network (IOWN) has been proposed (see Non Patent Literatures 1 and 3, for example). Particularly, an all-phonics network (APN) which is one of elements constituting the IOWN has a concept of data transfer by light based on wavelength division multiplexing (WDM). It is possible to expect low power consumption, a low latency, and a considerable improvement in transmission capacity, the rate of which has been limited by a band of an electrical switch, by minimizing electrical processing in a communication path and thereby reducing electrical processing such as frame reading and routing processing, which have been performed in the IP-based network.

If attention is paid to a transmission scheme that realizes an IOWN use case, there are digital coherent transmission and intensity modulation direct detection (IMDD) transmission. According to the digital coherent transmission, it is possible to realize significantly higher reception sensitivity as compared with the direct detection and thereby to significantly extend a transmission distance by combining a coherent reception technology and a digital signal processing (digital signal processor (DSP)).

However, there are problems in terms of an increase in costs due to preparation of local light on a reception side and an increase in power consumption due to the digital signal processing. On the other hand, the intensity modulation direct detection (IM-DD) scheme is a transmission scheme mainly for short-distance transmission such as an access network and a mobile fronthaul, and has a simple transceiver configuration, and is thus excellent in low power consumption and economy. In the APN, it is important to reduce costs and power consumption of the entire network by selectively using digital coherent transmission and IMDD transmission in accordance with a service or an application to be applied.

However, a limitation of a transmission distance due to an influence of wavelength dispersion is problematic in high-speed transmission using the IMDD scheme, and a variety of dispersion compensation schemes have thus far been proposed. On the other hand, it is known that a chirp which is a temporal change in frequency occurs due to a change in wavelength and a change in bias voltage to a modulator in an electro-absorption (EA) modulator used to realize economical high-speed transmission in the IMDD scheme. It is known that the chirp interacts with wavelength dispersion, causes a change in path penalty, and increases or decreases a distance by which a signal can be propagated.

There is a network compensation that performs dispersion compensation by an optical switch selecting an optical path (see Patent Literature 1, for example). It is assumed that dynamic dispersion compensation is performed by combining the network configuration with a function of calculating a dispersion amount from information regarding a distance between user devices and the like.

### CITATION LIST

### Patent Literature

### Patent Literature 1: JP 2008-60682 A

### Non Patent Literature

Non Patent Literature 1: Kawahara et al., “All-photonics network wo sasaeru hikari full-mesh network kousei gijutsu (in Japanese) (Optical Full-mesh Network Configuration Technology Supporting All-Photonics Network)”, NTT Technical Journal, Vol. 32 No. 3, 2020, pp. 18-21
Non Patent Literature 2:“Cyberphysical gijutsu kaihatsu no torikumi-edge AI, AR/VR gijutsu no doko to jirei (in Japanese) (Approach to Development of Cyberphysical Technology-Trends and Cases of Edge AI, AR/VR Technologies)”, NTT data, NTT Technical Journal, Vol. 31 No. 3, 2019, pp. 48-51
Non Patent Literature 3:“‘NTT Technology Report for Smart World: What's IOWN?’ no happyo ni tsuite (in Japanese) (Concerning Release of ‘NTT Technology Report for Smart World: What's IOWN?’)” [online], [retrieved on May 16, 2022], the Internet <URL: https://group.ntt/jp/newsrelease/2019/05/09/190509b.html)>

### SUMMARY OF INVENTION

### Technical Problem

However, the technology described in Patent Literature 1 does not take an α parameter that may affect a change in transmittable distance into consideration, and there is thus a problem that desired reception sensitivity cannot be obtained due to a change in α parameter.

In view of the above circumstances, an object of the present invention is to provide a technology that enables variations in transmittable distance that are attributable to a change in α parameter to be curbed.

### Solution to Problem

An aspect of the present invention is an optical transmission system including: an optical switch that includes a plurality of ports, outputs an optical signal input from any one of the ports from a different one of the ports, and acquires transmission path information on the basis of the optical signal input to the port; a plurality of dispersion compensation units that compensate for quality of the optical signal output from the optical switch and input the optical signal with the compensated quality to the optical switch; an α parameter measurement unit that acquires an α parameter indicating a chirp level on the basis of the optical signal with the compensated quality; and a control unit that performs correction of the α parameter or adjustment of a dispersion compensation amount in a case where a condition indicating that a problem that is attributable to the α parameter has occurred is satisfied on the basis of a cumulative wavelength dispersion amount or a transmission distance obtained on the basis of the transmission path information and the α parameter.

An aspect of the present invention is an adjustment method including: by an optical switch including a plurality of ports, outputting an optical signal input from any one of the ports from a different one of the ports and acquiring transmission path information on the basis of the optical signal input from the port; compensating for quality of the optical signal output from the optical switch and inputting the optical signal with the compensated quality to the optical switch; acquiring an α parameter indicating a chirp level on the basis of the optical signal with the compensated quality; and performing correction of the α parameter or adjustment of a dispersion compensation amount in a case where a condition indicating that a problem that is attributable to the α parameter has occurred is satisfied on the basis of a cumulative wavelength dispersion amount or a transmission distance obtained on the basis of the transmission path information and the α parameter.

### Advantageous Effects of Invention

According to the present invention, it is possible to curb variations in transmittable distance that are attributable to a change in α parameter.

### BRIEF DESCRIPTION OF DRAWINGS

FIG. 1 A diagram illustrating a configuration example of an optical transmission system according to a first embodiment.

FIG. 2 A diagram illustrating a configuration example of a correction table according to the first embodiment.

FIG. 3 A diagram illustrating a configuration example of a transmission path information table according to the first embodiment.

FIG. 4 A diagram illustrating a configuration example of an allowable range table according to the first embodiment.

FIG. 5 A sequence diagram illustrating a flow of processing of the optical transmission system according to the first embodiment.

FIG. 6 A diagram illustrating a configuration example of an optical transmission system according to a second embodiment.

FIG. 7 A sequence diagram illustrating a flow of processing of the optical transmission system according to the second embodiment.

FIG. 8 A diagram illustrating a configuration example of an optical transmission system according to a third embodiment.

FIG. 9 A diagram illustrating a configuration example of an allowable range table according to the third embodiment.

FIG. 10 A diagram illustrating a configuration example of a transmission distance table according to the third embodiment.

FIG. 11 A sequence diagram illustrating a flow of processing of the optical transmission system according to the third embodiment.

FIG. 12 A diagram illustrating a configuration example of an optical transmission system according to a fourth embodiment.

FIG. 13 A diagram illustrating a configuration example of a dispersion table according to the fourth embodiment.

FIG. 14 A sequence diagram illustrating a flow of processing of the optical transmission system according to the fourth embodiment.

FIG. 15 A diagram illustrating a configuration example of an optical transmission system according to a fifth embodiment.

FIG. 16 A sequence diagram illustrating a flow of processing of the optical transmission system according to the fifth embodiment.

FIG. 17 A diagram illustrating a configuration example of an optical transmission system according to a sixth embodiment.

FIG. 18 A sequence diagram illustrating a flow of processing of the optical transmission system according to the sixth embodiment.

Hereinafter, an embodiment of the present invention will be described with reference to drawings. In the drawings, the same parts will be denoted by the same reference signs, and the description thereof will be omitted.

### First Embodiment

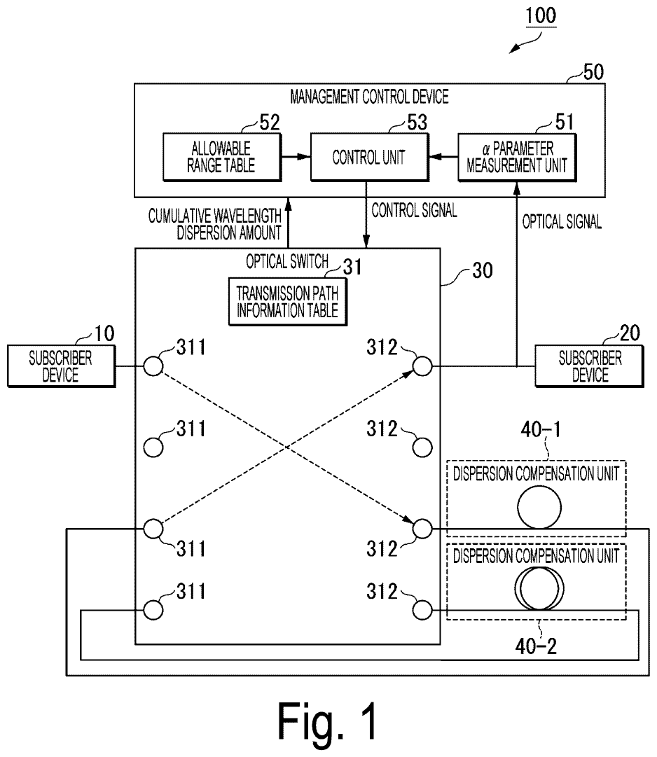

FIG. 1 is a diagram illustrating a configuration example of an optical transmission system 100 according to a first embodiment. The optical transmission system 100 includes one or more subscriber devices 10, one or more subscriber devices 20, an optical switch 30, a plurality of dispersion compensation units 40-1 and 40-2, and a management control device 50. Connection is established between the one or more subscriber devices 10 and the optical switch 30 and between the one or more subscriber devices 20 and the optical switch 30 by using an optical transmission path.

Note that although a case where an optical signal is transmitted from the subscriber device 10 to the subscriber device 20 will be described as an example in the following description, it is also possible to transmit an optical signal from the subscriber device 20 to the subscriber device 10. In the case where an optical signal is transmitted from the subscriber device 20 to the subscriber device 10, in the following description, the subscriber device 10 may be read as the subscriber device 20 and the subscriber device 20 may be read as the subscriber device 10.

The subscriber device 10 transmits an optical signal directed to the subscriber device 20. Furthermore, the subscriber device 10 receives a control signal transmitted from the management control device 50. The control signal includes information for remedying degradation of a bit error rate (BER). More specifically, the control signal includes an α parameter correction amount or a target α parameter value (hereinafter, referred to as an “α parameter correction value”) used for correcting an α parameter of the subscriber device 10.

The α parameter is an amount represented by a ratio of conversion amounts of a refractive index and a light absorption amount when they change (a ratio of a change in refractive index with respect to a change in absorption coefficient), that is, an amount represented by (a change in refractive index/a change in absorption coefficient). The smaller an absolute value of the α parameter is, the smaller a wavelength chirp becomes. The wavelength chirp means variations in wavelength occurring at rising and falling parts of an optical pulse. Since an optical speed differs depending on a wavelength in an optical transmission path, a strain may occur in the wavelength of the optical pulse to which a large wavelength chirp is given during transmission. This makes long-distance transmission difficult. Specific description regarding the α parameter is given in Reference Literature 1 below.

(Reference Literature 1: F. Koyama and K. Iga, “Frequency chirping in external modulators”, in Journal of Lightwave Technology, vol. 6, no. 1, pp. 87-93, January 1988, doi: 10.1109/50.3969.)

In the first embodiment, the subscriber device 10 holds a table in which information for correcting the α parameter is registered (hereinafter, referred to as a “correction table”). The subscriber device 10 performs changing of a bias voltage and fine adjustment of a frequency on the basis of the α parameter correction value provided as a notification from the management control device 50. Information regarding target values of the bias voltage and the frequency is obtained by referring to the correction table on the basis of a transmission rate and a modulation scheme.

In a case where there are differences in a current frequency, bias voltage, and α parameter values predicted from information in the correction table with respect to the α parameter correction value provided as a notification from the management control device 50 when the subscriber device 10 performs correction of the α parameter, fine adjustment is repeated until the α parameter correction value is reached with reference to a sign of the correction amount.

The subscriber device 20 is a device as a target that performs communication with the subscriber device 10. The subscriber device 20 transmits and receives optical signals to and from the subscriber device 10.

The optical switch 30 includes a plurality of input ports 311 and a plurality of output ports 312. The optical switch 30 outputs an optical switch input from the input ports 311 to the output ports 312 and outputs the optical signal input from the output ports 312 to the input ports 311. The optical switch 30 has a function of changing a connection relationship between the input ports 311 and the output ports 312. It is possible to change a path through which the optical signal is transmitted by changing the connection relationship between the input ports 311 and the output ports 312.

Some of the input ports 311 of the optical switch 30 is connected to the subscriber device 10 via an optical transmission path, and some of the output ports 312 of the optical switch 30 is connected to the subscriber device 20 via the optical transmission path. An optical splitter is provided on the optical transmission path connecting the optical switch 30 to the subscriber device 20. An optical signal to be transmitted to the subscriber device 20 is branched and input to the subscriber device 20 and the management control device 50 by the optical splitter. Some of the input ports 311 and some of the output ports 312 of the optical switch 30 are connected to the dispersion compensation units 40-1 and 40-2 via the optical transmission path.

Furthermore, the optical switch 30 has a function (light receiving unit) of acquiring an input optical signal input to the input ports 311 and acquiring transmission path information on the basis of the acquired optical signal. The transmission path information includes information regarding a transmission source, information regarding a transmission destination, information regarding a wavelength, information regarding a modulation scheme, information regarding a transmission rate, information regarding wavelength dispersion of a fiber as a path, and the like. Furthermore, the optical switch 30 has a function (information acquisition unit) of acquiring a transmission distance, an allowable dispersion amount, and a cumulative wavelength dispersion amount on the basis of the acquired transmission path information. Specifically, the optical switch 30 calculates the transmission distance on the basis of the information regarding the transmission source and the information regarding the transmission destination. Furthermore, the optical switch 30 calculates an allowable dispersion amount (derived from service quality and device information) on the basis of the information regarding the transmission source, the information regarding the transmission destination, the information regarding the wavelength, the information regarding the modulation scheme, and the information regarding the transmission rate. Then, the optical switch 30 calculates a cumulative wavelength dispersion amount on the basis of the calculated transmission distance and fiber wavelength dispersion. The optical switch 30 holds a transmission path information table 31 in which the transmission path information and the information regarding the acquired transmission distance, the allowable dispersion amount, and the cumulative wavelength dispersion amount are registered. The optical switch 30 notifies the management control device 50 of the acquired information regarding the cumulative wavelength dispersion amount.

The dispersion compensation units 40-1 and 40-2 compensate for quality of the optical signal. The dispersion compensation units 40-1 and 40-2 compensate for dispersion of the optical signal output from the output ports 312 of the optical switch 30 and input the optical signal with compensated dispersion to the input ports 311 of the optical switch 30. The dispersion compensation units 40-1 and 40-2 are dispersion compensation fibers having different lengths. Therefore, the dispersion amounts by which the dispersion compensation units 40-1 and 40-2 can compensate differ from each other. Note that although FIG. 1 illustrates an example in which there are two dispersion compensation units 40, the number of dispersion compensation units 40 may be three or more. In the case where the number of dispersion compensation units 40 is three or more, the dispersion amounts by which some of the plurality of dispersion compensation units 40 can compensate may be the same.

The management control device 50 controls the entire optical transmission system 100. The management control device 50 detects a problem that is attributable to the α parameter and remedies the problem caused by the α parameter. The problem that is attributable to the α parameter is degradation of BER in accordance with a change in α parameter. The management control device 50 according to the first embodiment detects the problem that is attributable to the α parameter on the basis of the cumulative wavelength dispersion amount obtained by the optical switch 30. Furthermore, the management control device 50 according to the first embodiment remedies the problem that is attributable to the α parameter by causing the α parameter of the subscriber device 10 which is a transmission source to be changed. Specifically, the management control device 50 remedies the problem by transmitting a control signal including an α parameter correction value to the subscriber device 10 which is a transmission source via the optical switch 30 and changing a bias voltage or the like to cause the α parameter to be changed.

The management control device 50 includes an α parameter measurement unit 51, an allowable range table 52, and a control unit 53.

An optical signal, the wavelength dispersion of which has been compensated, is branched by an optical splitter and is input to the α parameter measurement unit 51. The α parameter measurement unit 51 converts the input optical signal, the wavelength dispersion of which has been compensated, into an electrical signal and then extracts phase information. The α parameter measurement unit 51 measures the α parameter from the phase information of the signal. Examples of an α parameter measurement method include a coherent receiver.

The allowable range table 52 is a table in which information regarding a range indicated by a maximum value and a minimum value of a cumulative wavelength dispersion amount that is allowed for each α parameter (hereinafter, referred to as a “dispersion amount allowable range”) is registered. The dispersion amount allowable range is a range in which it is possible to consider that an influence on communication is small due to small degradation of BER.

The control unit 53 determines whether or not a problem that is attributable to the α parameter has occurred on the basis of the allowable range table 52, the α parameter measured by the α parameter measurement unit 51, and the information regarding the cumulative wavelength dispersion amount provided as a notification from the optical switch 30. Hereinafter, the fact that the problem that is attributable to the α parameter has occurred will be described as a correction condition having been satisfied, and the fact that the problem that is attributable to the α parameter has not occurred will be described as the correction condition having not been satisfied.

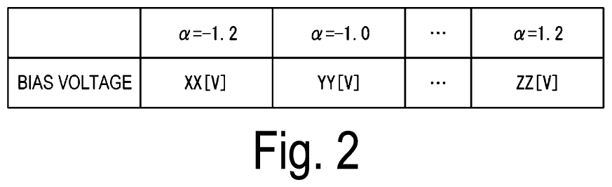

FIG. 2 is a diagram illustrating a configuration example of a correction table according to the first embodiment. A bias voltage value is registered for each α parameter in the correction table. Note that the bias voltage value in the correction table illustrated in FIG. 2 is a value in a case of a center frequency=N, 25 giga bit per second (Gbps), and a binary. The example illustrated in FIG. 2 illustrates that the bias voltage is “XX [V]” in a case where the α parameter is “−1.2”.

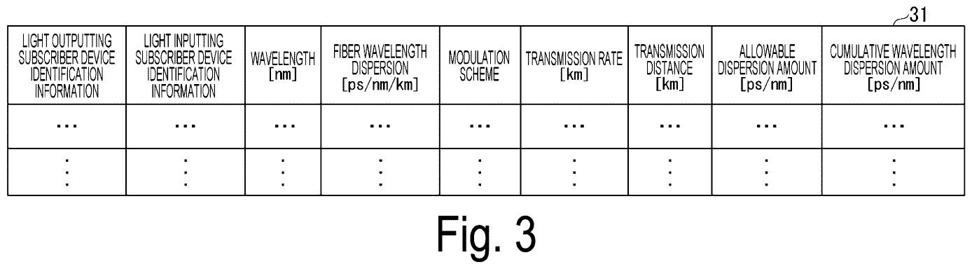

FIG. 3 is a diagram illustrating a configuration example of a transmission path information table 31 according to the first embodiment. The transmission path information table 31 includes a plurality of records representing information regarding transmission path information. The records include each of values of light outputting subscriber device identification information, light inputting subscriber device identification information, a wavelength, fiber wavelength dispersion, a modulation scheme, a transmission rate, a transmission distance, an allowable dispersion amount, and a cumulative wavelength dispersion amount. The light outputting subscriber device identification information represents identification information of a subscriber device that is a transmission source of an optical signal. The light inputting subscriber device identification information represents identification information of a subscriber device that is a transmission destination of the optical signal. The wavelength represents a wavelength of the optical signal. The fiber wavelength dispersion represents the amount of wavelength dispersion that has occurred in an optical transmission path through which the optical signal has been transmitted. The modulation scheme represents a modulation scheme executed on the optical signal. The transmission rate represents a transmission rate of the optical signal. The transmission distance represents a distance between the subscriber device 10 and the optical switch 30. The allowable dispersion amount represents an allowable dispersion amount. The cumulative wavelength dispersion amount represents the cumulative amount of wavelength dispersion.

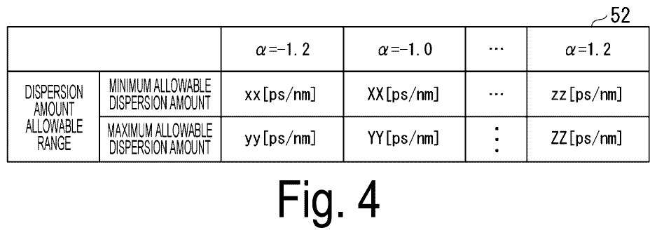

FIG. 4 is a diagram illustrating a configuration example of the allowable range table 52 according to the first embodiment. Values of a minimum allowable dispersion amount and a maximum allowable dispersion amount are registered for each combination of the dispersion amount allowable range and the α parameter in the allowable range table 52. The example illustrated in FIG. 4, for example, illustrates that the minimum allowable dispersion amount is “xx [ps/nm]” and the maximum allowable dispersion amount is “yy [ps/nm] in a case where the α parameter is “−1.2”. A range between the minimum allowable dispersion amount and the maximum allowable dispersion amount is a dispersion amount allowable range.

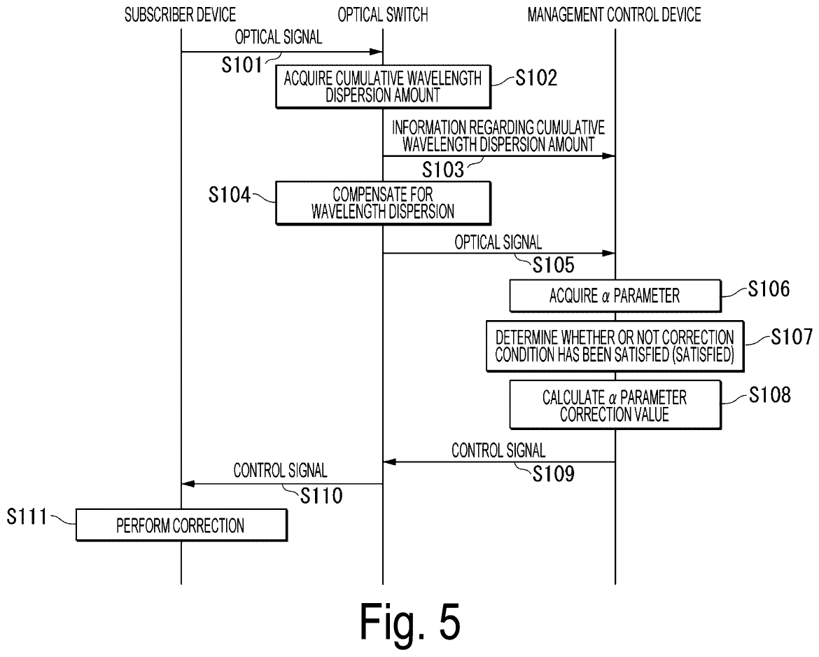

FIG. 5 is a sequence diagram illustrating a flow of processing of the optical transmission system 100 according to the first embodiment. Note that it is assumed that the connection relationship between the input ports 311 and the output ports 312 of the optical switch 30 is as illustrated in FIG. 1 in the processing in FIG. 5.

The subscriber device 10 transmits an optical signal directed to the subscriber device 20 (step S101). The optical signal transmitted from the subscriber device 10 is input to an input port 311 of the optical switch 30 via an optical transmission path. The optical signal input to the input port 311 is output from an output port 312 to which the dispersion compensation unit 40-1 is connected. Before the optical signal input to the input port 311 is output from the output port 312, the optical switch 30 acquires the optical signal and acquires transmission path information on the basis of the acquired optical signal. Note that the optical switch 30 may acquire the transmission path information on the basis of an optical signal, wavelength dispersion of which has been compensated.

The optical switch 30 acquires a cumulative wavelength dispersion amount on the basis of the acquired transmission path information and the transmission path information table 31 (step S102). The optical switch 30 notifies the management control device 50 of information regarding the acquired cumulative wavelength dispersion amount (step S103). Note that the notification of the information regarding the cumulative wavelength dispersion amount from the optical switch 30 to the management control device 50 may be performed via an electric line connecting the optical switch 30 and the management control device 50. The control unit 53 of the management control device 50 acquires the information regarding the cumulative wavelength dispersion amount provided as a notification from the optical switch 30.

Wavelength dispersion of the optical signal output from the output port 312 of the optical switch 30 is compensated by the dispersion compensation unit 40-1, and the optical signal is then input to an input port 311 to which the dispersion compensation unit 40-1 is connected (step S104). The optical signal input to the input port 311 to which the dispersion compensation unit 40-1 is connected is output from an output port 312 to which the subscriber device 20 is connected. The optical signal output from the output port 312 to which the subscriber device 20 is connected is branched by an optical splitter. The branched optical signal is input to the management control device 50 and the subscriber device 20 (step S105).

The α parameter measurement unit 51 of the management control device 50 acquires the α parameter by using the input optical signal, the wavelength dispersion of which has been compensated (step S106). The α parameter measurement unit 51 outputs the acquired α parameter to the control unit 53. The control unit 53 determines whether or not the correction condition has been satisfied on the basis of the information regarding the cumulative wavelength dispersion amount, the allowable range table 52, and the α parameter (step S107).

Specifically, the control unit 53 specifies the dispersion amount allowable range on the basis of the allowable range table 52 and the α parameter first. In a case where the α parameter is “−1.2”, for example, the control unit 53 specifies, as the dispersion amount allowable range, a range from the minimum allowable dispersion amount “xx [ps/nm]” to the maximum allowable dispersion amount “yy [ps/nm]” as illustrated in FIG. 4. In a case where the cumulative wavelength dispersion amount provided as a notification from the optical switch 30 is within the specified dispersion amount allowable range, then the control unit 53 determines that a problem that is attributable to the α parameter has not occurred. On the other hand, in a case where the cumulative wavelength dispersion amount provided as a notification from the optical switch 30 is outside the specified dispersion amount allowable range, the control unit 53 determines that the problem that is attributable to the α parameter has occurred. Note that it is assumed here that the correction condition is determined to have been satisfied (the problem that is attributable to the α parameter has occurred).

The control unit 53 calculates an α parameter correction value on the basis of the cumulative wavelength dispersion amount (step S108). Specifically, in a case where the cumulative wavelength dispersion amount is above the maximum value of the dispersion amount allowable range, the control unit 53 calculates, as the α parameter correction value, an α parameter correction amount to reduce the α parameter (for example, the α parameter correction amount to cause the α parameter to be corrected to fall within the dispersion amount allowable range) or a target α parameter value. In a case where the cumulative wavelength dispersion amount is below the minimum value of the dispersion amount allowable range, the control unit 53 calculates, as the α parameter correction value, an α parameter correction amount to increase the α parameter or an α parameter as a target. The control unit 53 notifies the optical switch 30 of the information regarding the calculated α parameter correction value as a control signal (step S109). For example, the notification of the control signal from the management control device 50 to the optical switch 30 may be performed via an electric line.

The optical switch 30 receives the control signal provided as a notification from the management control device 50. The optical switch 30 converts the received control signal into an optical signal and transmits the optical signal to the subscriber device 10 (step S110). Specifically, the optical switch 30 transmits the optical signal to the subscriber device 10 by outputting the optical signal from the input port 311 to which the subscriber device 10 is connected.

The subscriber device 10 receives the optical signal transmitted from the optical switch 30. The subscriber device 10 converts the received optical signal into an electrical signal and acquires the information regarding the α parameter correction value. The subscriber device 10 performs changing of the bias voltage and fine adjustment of the frequency on the basis of the acquired information regarding the α parameter correction value and the correction table (step S111).

According to the optical transmission system 100 configured as described above, it is possible to curb variations in transmittable distance that are attributable to a change in α parameter. Specifically, the optical transmission system 100 includes the optical switch 30 that acquires the transmission path information on the basis of the input optical signal, the plurality of dispersion compensation units 40 that compensate for quality of the optical signal output from the optical switch 30 and input the optical signal, the quality of which has been compensated, to the optical switch 30, the α parameter measurement unit 51 that acquires the α parameter indicating a chirp level on the basis of the optical signal, the quality of which has been compensated, and the control unit 53 that adjusts the correction of the α parameter in a case where the condition indicating that a problem that is attributable to the α parameter has occurred is satisfied on the basis of the cumulative wavelength dispersion amount obtained on the basis of the transmission path information and the α parameter. In this manner, a detection in a case of failing to fall within a dispersion compensation range due to variations in α parameter is performed. Furthermore, in a case where a problem has been detected, the management control device 50 transmits a correction command to the optical switch 30 and corrects the α parameter of the subscriber device 10 which is a transmission source of the optical signal. It is thus possible to address a change in dispersion compensation range due to variations in α parameter. Therefore, it is possible to curb variations in transmittable distance that are attributable to a change in α parameter.

Hereinafter, a modification example of the optical transmission system 100 will be described.

The aforementioned embodiment illustrates the configuration in which the control unit 53 determines that the correction condition has been satisfied in the case where the cumulative wavelength dispersion amount is outside the dispersion amount allowable range. The control unit 53 may be configured to determine that the correction condition has been satisfied in a case where the cumulative wavelength dispersion amount deviates from a threshold value within the prescribed dispersion amount allowable range as well in addition to the case where the cumulative wavelength dispersion amount fails to fall within the dispersion amount allowable range. The threshold value may be appropriately set. With such a configuration, it is possible to perform correction in advance in view of future variations in α parameter.

### Second Embodiment

In a second embodiment, a configuration in which a management control device holds a transmission path information table that the optical switch holds will be described.

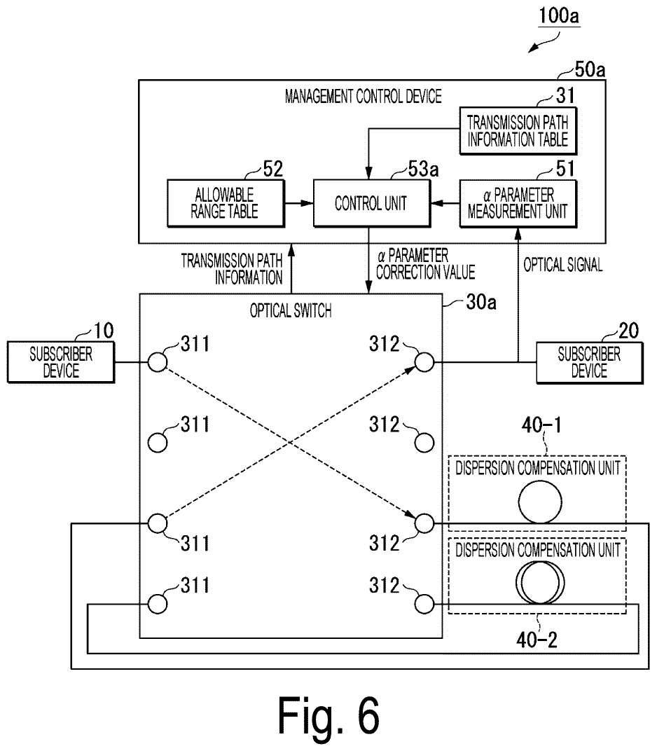

FIG. 6 is a diagram illustrating a configuration example of an optical transmission system 100a according to the second embodiment. The optical transmission system 100a includes one or more subscriber devices 10, one or more subscriber devices 20, an optical switch 30a, a plurality of dispersion compensation units 40-1 and 40-2, and a management control device 50a.

The optical switch 30a has a different configuration from that of the optical switch 30 in that the optical switch 30a does not include a transmission path information table 31 and notifies the management control device 50a of transmission path information rather than information regarding a cumulative wavelength dispersion amount. In this manner, the optical switch 30a does not acquire the cumulative wavelength dispersion amount. The optical switch 30a is similar to the optical switch 30 in regard to the other configurations.

The management control device 50a has a different configuration from that of the management control device 50 in that the management control device 50a acquires the cumulative wavelength dispersion amount on the basis of transmission path information provided as a notification from the optical switch 30a. The management control device 50a includes an α parameter measurement unit 51, an allowable range table 52, a control unit 53a, and a transmission path information table 31. In this manner, the management control device 50a newly includes the transmission path information table 31, which is included by the optical switch 30 in the first embodiment.

The control unit 53a acquires the cumulative wavelength dispersion amount on the basis of the transmission path information table 31 and the transmission path information provided as a notification from the optical switch 30a. The control unit 53a determines whether or not a problem that is attributable to an α parameter has occurred on the basis of the acquired cumulative wavelength dispersion amount, the allowable range table 52, and the α parameter measured by the α parameter measurement unit 51. The determination regarding whether or not the problem that is attributable to the α parameter has occurred is similar to that in the first embodiment.

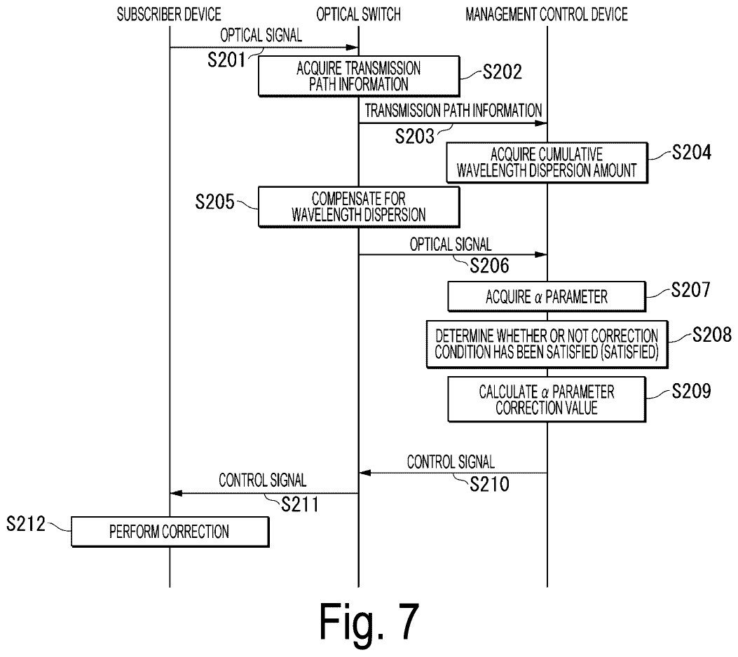

FIG. 7 is a sequence diagram illustrating a flow of processing of the optical transmission system 100a according to the second embodiment. Note that it is assumed that the connection relationship between input ports 311 and output ports 312 of the optical switch 30a is as illustrated in FIG. 6 in the processing in FIG. 7.

A subscriber device 10 transmits an optical signal directed to a subscriber device 20 (step S201). The optical signal transmitted from the subscriber device 10 is input to an input port 311 of the optical switch 30a via an optical transmission path. The optical signal input to the input port 311 is output from an output port 312 to which the dispersion compensation unit 40-1 is connected. Before the optical signal input to the input port 311 is output from the output port 312, the optical switch 30a acquires the optical signal and acquires transmission path information on the basis of the acquired optical signal (step S202). Note that the optical switch 30a may acquire the transmission path information on the basis of the optical signal, wavelength dispersion of which has been compensated.

The optical switch 30a notifies the management control device 50a of the acquired transmission path information (step S203). Note that the notification of the transmission path information from the optical switch 30a to the management control device 50a may be performed via an electric line connecting the optical switch 30a and the management control device 50a.

The control unit 53a of the management control device 50a acquires the transmission path information provided as a notification from the optical switch 30a. The control unit 53a acquires a cumulative wavelength dispersion amount on the basis of the acquired transmission path information and the transmission path information table 31 (step S204).

Wavelength dispersion of the optical signal output from the output port 312 of the optical switch 30a is compensated by a dispersion compensation unit 40-1, and the optical signal is then input to an input port 311 to which the dispersion compensation unit 40-1 is connected (step S205). The optical signal input to the input port 311 to which the dispersion compensation unit 40-1 is connected is output from an output port 312 to which the subscriber device 20 is connected. The optical signal output from the output port 312 to which the subscriber device 20 is connected is branched by an optical splitter. The branched optical signal is input to the management control device 50a and the subscriber device 20 (step S206).

The α parameter measurement unit 51 of the management control device 50a acquires the α parameter by using the input optical signal, the wavelength dispersion of which has been compensated (step S207). The α parameter measurement unit 51 outputs the acquired α parameter to the control unit 53a. The control unit 53a determines whether or not the correction condition has been satisfied on the basis of the acquired information regarding the cumulative wavelength dispersion amount, the allowable range table 52, and the α parameter (step S208). Note that it is assumed here that the correction condition is determined to have been satisfied (the problem that is attributable to the α parameter has occurred).

The control unit 53a calculates an α parameter correction value on the basis of the cumulative wavelength dispersion amount (step S209). Specific processing is similar to that in the first embodiment. The control unit 53a notifies the optical switch 30a of the information regarding the calculated α parameter correction value as a control signal (step S210). For example, the notification of the control signal from the management control device 50a to the optical switch 30a may be performed via an electric line.

The optical switch 30a receives the control signal provided as a notification from the management control device 50a. The optical switch 30a converts the received control signal into an optical signal and transmits the optical signal to the subscriber device 10 (step S211). Specifically, the optical switch 30a transmits the optical signal to the subscriber device 10 by outputting the optical signal from the input port 311 to which the subscriber device 10 is connected.

The subscriber device 10 receives the optical signal transmitted from the optical switch 30a. The subscriber device 10 converts the received optical signal into an electrical signal and acquires the information regarding the α parameter correction value. The subscriber device 10 performs changing of the bias voltage and fine adjustment of the frequency on the basis of the acquired information regarding the α parameter correction value and the correction table (step S212).

According to the optical transmission system 100a configured as described above, effects similar to those of the first embodiment can be obtained.

Hereinafter, a modification example of the optical transmission system 100a will be described.

The optical transmission system 100a may be modified similarly to the first embodiment.

### Third Embodiment

In the first embodiment and the second embodiment, the problem that is attributable to the α parameter is detected on the basis of the cumulative wavelength dispersion amount obtained by the optical switch 30. In a third embodiment, a configuration in which the problem that is attributable to the α parameter is detected on the basis of a transmission distance will be described. Hereinafter, differences from the second embodiment will be described.

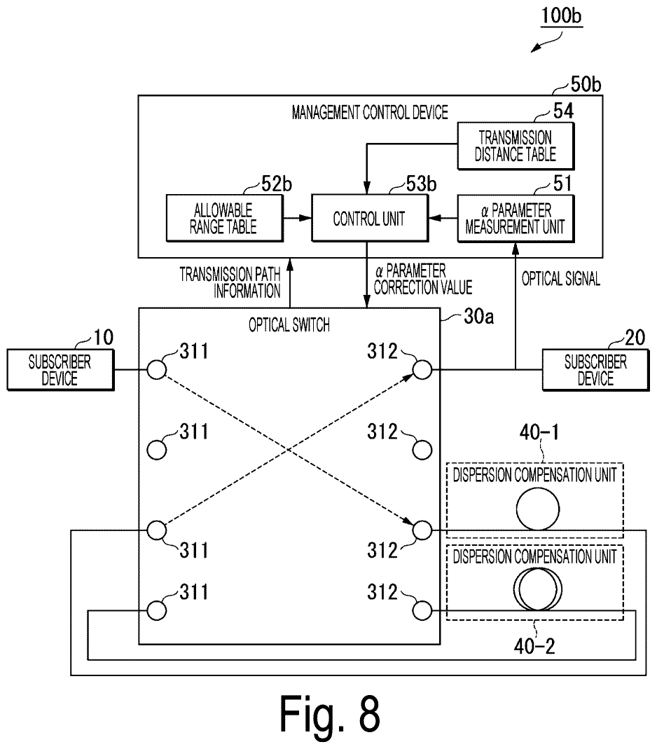

FIG. 8 is a diagram illustrating a configuration example of an optical transmission system 100b according to the third embodiment. The optical transmission system 100b includes one or more subscriber devices 10, one or more subscriber devices 20, an optical switch 30a, a plurality of dispersion compensation units 40-1 and 40-2, and a management control device 50b.

The management control device 50b is different from that in the second embodiment in that a problem that is attributable to an α parameter is detected on the basis of a transmission distance. The management control device 50b includes an α parameter measurement unit 51, an allowable range table 52b, a control unit 53b, and a transmission distance table 54.

The allowable range table 52b is configured of a plurality of allowable range tables for each combination of a wavelength, a modulation scheme, and a transmission rate. Each allowable range table 52b is a table in which information regarding a range indicated by a maximum value and a minimum value of a transmission distance that is allowed for each α parameter (hereinafter, referred to as a “transmission distance allowable range”) is registered. The transmission distance allowable range is a range in which it is possible to consider that an influence on communication is small due to small degradation of BER.

The control unit 53b determines whether or not a problem that is attributable to the a parameter has occurred on the basis of the allowable range table 52b, the α parameter measured by the α parameter measurement unit 51, the transmission path information provided as a notification from the optical switch 30a, and the transmission distance table 54.

The transmission distance table 54 is a table in which information regarding the transmission distance is registered.

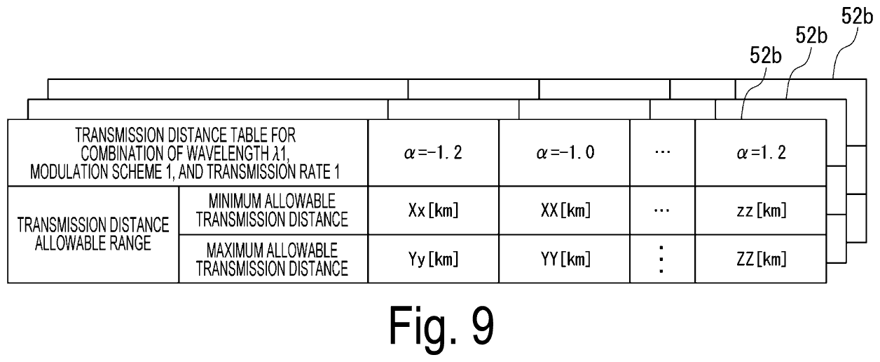

FIG. 9 is a diagram illustrating a configuration example of the allowable range table 52b according to the third embodiment. The allowable range table 52b is present for each combination of the wavelength, the modulation scheme, and the transmission rate as illustrated in FIG. 9. Values of a minimum allowable transmission distance and a maximum allowable transmission distance are registered for each combination of the transmission distance allowable range and the α parameter in each allowable range table 52b. The example illustrated in FIG. 9, for example, illustrates that the minimum allowable transmission distance is “Xx [km]” and the maximum allowable transmission distance is “Yy [km]” in a case where the α parameter is “−1.2” in the allowable range table 52b for a combination of a wavelength λ1, a modulation scheme 1, and a transmission rate 1. A range between the minimum allowable transmission distance and the maximum allowable transmission distance is the transmission distance allowable range.

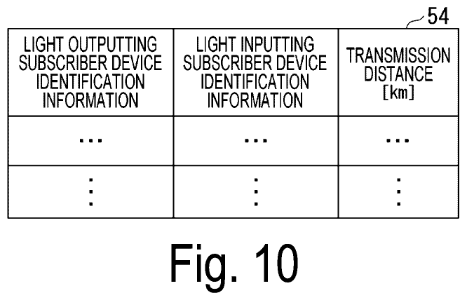

FIG. 10 is a diagram illustrating a configuration of the transmission distance table 54 according to the third embodiment. The transmission distance table 54 includes a plurality of records representing information regarding the transmission distance. The records include each of values of light outputting subscriber device identification information, light inputting subscriber device identification information, and the transmission distance. The light outputting subscriber device identification information represents identification information of a subscriber device that is a transmission source of an optical signal. The light inputting subscriber device identification information represents identification information of a subscriber device that is a transmission destination of the optical signal. The transmission distance represents a distance between the subscriber device that is a transmission source of the optical signal and the subscriber device that is a transmission destination of the optical signal.

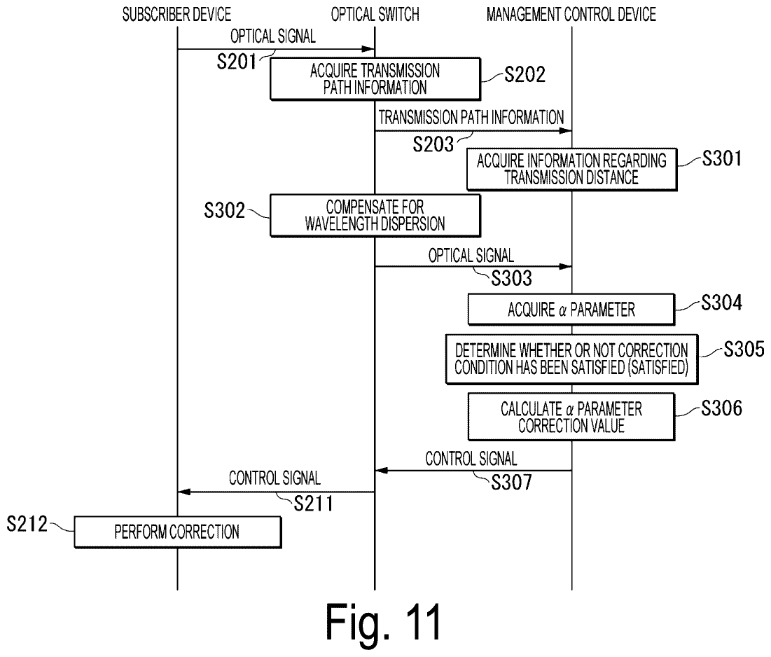

FIG. 11 is a sequence diagram illustrating a flow of processing of the optical transmission system 100b according to the third embodiment. Note that it is assumed that the connection relationship between input ports 311 and output ports 312 of the optical switch 30a is as illustrated in FIG. 8 in the processing in FIG. 11. In FIG. 11, the same processing as that in FIG. 7 will be denoted by the same reference sign as that in FIG. 7, and description thereof will be omitted.

After the processing in step S201 to step S203 ends, the control unit 53b of the management control device 50b acquires the transmission path information provided as a notification from the optical switch 30a. The control unit 53b acquires information regarding the transmission distance on the basis of the acquired transmission path information and the transmission distance table 54 (step S301). Specifically, the control unit 53b acquires information regarding the transmission source and information regarding the transmission destination included in the acquired transmission path information. The control unit 53b refers to the transmission distance table 54 and acquires information regarding the transmission distance corresponding to the acquired combination of the information regarding the transmission source and the information regarding the transmission destination.

Wavelength dispersion of the optical signal output from the output port 312 of the optical switch 30a is compensated by the dispersion compensation unit 40-1, and the optical signal is then input to an input port 311 to which the dispersion compensation unit 40-1 is connected (step S302). The optical signal input to the input port 311 to which the dispersion compensation unit 40-1 is connected is output from an output port 312 to which the subscriber device 20 is connected. The optical signal output from the output port 312 to which the subscriber device 20 is connected is branched by an optical splitter. The branched optical signal is input to the management control device 50b and the subscriber device 20 (step S303).

The α parameter measurement unit 51 of the management control device 50b acquires the α parameter by using the input optical signal, the wavelength dispersion of which has been compensated (step S304). The α parameter measurement unit 51 outputs the acquired α parameter to the control unit 53b. The control unit 53b determines whether or not the correction condition has been satisfied on the basis of the acquired information regarding the transmission distance, the allowable range table 52b, and the α parameter (step S305).

Specifically, the control unit 53b acquires the combination of the wavelength, the modulation scheme, and the transmission rate included in the transmission path information first.

Next, the control unit 53b selects an allowable range table 52b corresponding to the acquired combination of the wavelength, the modulation scheme, and the transmission rate. For example, it is assumed that an allowable range table 52b corresponding to a wavelength λ1, a modulation scheme 1, and a transmission rate 1 has been selected.

The control unit 53b specifies a transmission distance allowable range on the basis of the selected allowable range table 52b and the α parameter. In a case where the α parameter is “−1.2”, for example, the control unit 53b specifies, as the transmission distance allowable range, a range from the minimum allowable transmission distance “Xx [km]” to the maximum allowable transmission distance “Yy [km]” as illustrated in FIG. 9. In a case where the acquired transmission distance is within the specified selected transmission distance allowable range, then the control unit 53b determines that a problem that is attributable to the α parameter has not occurred. On the other hand, in a case where the acquired transmission distance is outside the specified selected transmission distance allowable range, the control unit 53b determines that the problem that is attributable to the α parameter has occurred. Note that it is assumed here that the correction condition is determined to have been satisfied (the problem that is attributable to the α parameter has occurred).

The control unit 53b calculates an α parameter correction value on the basis of the transmission distance (step S306). Specifically, in a case where the acquired transmission distance is above the maximum value of the transmission distance allowable range and fiber wavelength dispersion is positive, or in a case where the acquired transmission distance is below the minimum value of the transmission distance allowable range and the fiber wavelength dispersion is negative, the control unit 53b calculates, as an α parameter correction value, an α parameter correction amount to reduce the α parameter or a target α parameter value. In a case where the acquired transmission distance is above the maximum value of the transmission distance allowable range and fiber wavelength dispersion is negative, or in a case where the acquired transmission distance is below the minimum value of the transmission distance allowable range and the fiber wavelength dispersion is positive, the control unit 53b calculates, as an α parameter correction value, an α parameter correction amount to increase the α parameter or a target α parameter value. The control unit 53b notifies the optical switch 30a of the information regarding the calculated α parameter correction value as a control signal (step S307). For example, the notification of the control signal from the management control device 50b to the optical switch 30a may be performed via an electric line. Thereafter, the processing in and after step S211 is executed.

According to the optical transmission system 100b configured as described above, the management control device 50b determines whether or not the problem that is attributable to the α parameter has occurred on the basis of the transmission distance acquired on the basis of the transmission path information and the α parameter. In this manner, the management control device 50b can detect the problem that is attributable to the α parameter on the basis of the transmission distance unlike the first embodiment and the second embodiment. Furthermore, the control unit 53b adjusts correction of the α parameter in a case where a condition indicating that a problem that is attributable to the α parameter has occurred is satisfied. In a case where a problem has been detected, the management control device 50b transmits a correction command to the optical switch 30a and corrects the α parameter of the subscriber device 10 which is the transmission source of the optical signal in this manner. It is thus possible to address a change in dispersion compensation range due to variations in α parameter. Therefore, it is possible to curb variations in transmittable distance that are attributable to a change in α parameter.

Hereinafter, a modification example of the optical transmission system 100b will be described.

The aforementioned embodiment illustrates the configuration in which the control unit 53b determines that the correction condition has been satisfied in a case where the transmission distance is outside the transmission distance allowable range. The control unit 53b may be configured to determine that the correction condition has been satisfied in a case of failing to fall within a threshold value within a prescribed transmission distance allowable range as well in addition to the case where the transmission distance is outside the transmission distance allowable range. The threshold value may be appropriately set. With such a configuration, it is possible to perform correction in advance in view of future variations in α parameter.

### Fourth Embodiment

In the first embodiment to the third embodiment, the problem that is attributable to the α parameter is remedied by causing the α parameter of the subscriber device 10 which is the transmission source to be changed. In a fourth embodiment, a configuration in which the problem that is attributable to the α parameter is remedied by changing a cumulative wavelength dispersion amount of an entire optical path by using a dispersion compensation function of an optical switch will be described.

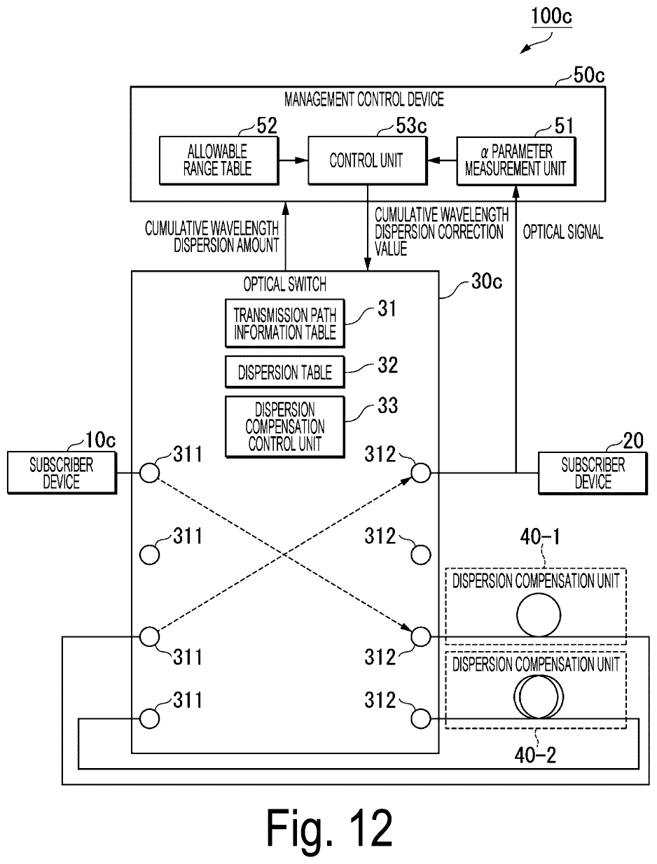

FIG. 12 is a diagram illustrating a configuration example of an optical transmission system 100c according to the fourth embodiment. The optical transmission system 100c includes one or more subscriber devices 10c, one or more subscriber devices 20, an optical switch 30c, a plurality of dispersion compensation units 40-1 and 40-2, and a management control device 50c. Connection is established between the one or more subscriber devices 10c and the optical switch 30c and between the one or more subscriber devices 20 and the optical switch 30c by using an optical transmission path.

The subscriber device 10c is different from the subscriber device 10 in that the subscriber device 10c does not hold the correction table and does not perform changing of the bias voltage and fine adjustment of the frequency on the basis of a control signal transmitted from the management control device 50c. The other configurations of the subscriber device 10c are similar to those of the subscriber device 10.

The optical switch 30c has a different configuration from that in the first embodiment to the third embodiment in that the optical switch 30c further includes a dispersion table 32 and a dispersion compensation control unit 33. The optical switch 30c notifies the management control device 50c of information regarding a cumulative wavelength dispersion amount similarly to the first embodiment.

The dispersion table 32 is a table in which information regarding dispersion compensation is registered.

The dispersion compensation control unit 33 receives a control signal transmitted from the management control device 50c. The control signal includes a cumulative wavelength dispersion amount correction value or a target cumulative wavelength dispersion value (hereinafter, referred to as a “cumulative wavelength dispersion correction value”) used to change the cumulative wavelength dispersion amount in the optical switch 30c. The target cumulative wavelength dispersion value is, for example, an allowable dispersion amount. The cumulative wavelength dispersion amount correction value is a value obtained by subtracting a current cumulative wavelength dispersion value from the target cumulative wavelength dispersion value. The dispersion compensation control unit 33 changes the cumulative wavelength dispersion amount of the transmission path by changing the dispersion compensation unit 40 to be applied or changing the path on the basis of the cumulative wavelength dispersion correction value.

The management control device 50c is different from those in the first embodiment to the third embodiment in that for the problem that is attributable to the α parameter, the cumulative wavelength dispersion amount of the entire optical path is changed by using the dispersion compensation function of the optical switch. The management control device 50c includes an α parameter measurement unit 51, an allowable range table 52, and a control unit 53c.

The control unit 53c determines whether or not the problem that is attributable to the α parameter has occurred by a method that is similar to that in the first embodiment. In a case where it is determined that the problem that is attributable to the α parameter has occurred, the control unit 53c calculates the cumulative wavelength dispersion correction value.

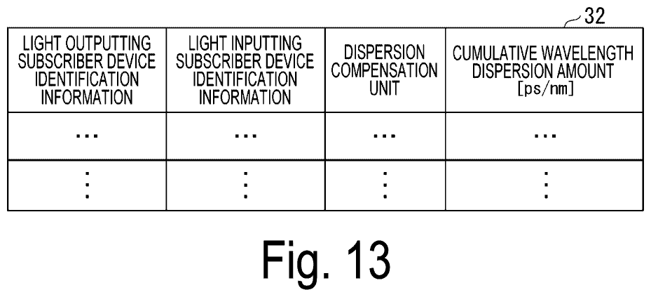

FIG. 13 is a diagram illustrating a configuration example of the dispersion table 32 according to the fourth embodiment. The dispersion table 32 includes a plurality of records representing information regarding wavelength dispersion. The records include each of values of light outputting subscriber device identification information, light inputting subscriber device identification information, the dispersion compensation unit, and the cumulative wavelength dispersion amount. The light outputting subscriber device identification information represents identification information of a subscriber device that is a transmission source of an optical signal. The light inputting subscriber device identification information represents identification information of a subscriber device that is a transmission destination of the optical signal. The dispersion compensation unit represents the dispersion compensation units 40-1 and 40-2. The cumulative wavelength dispersion amount represents the cumulative wavelength dispersion amount of each of the dispersion compensation units 40-1 and 40-2.

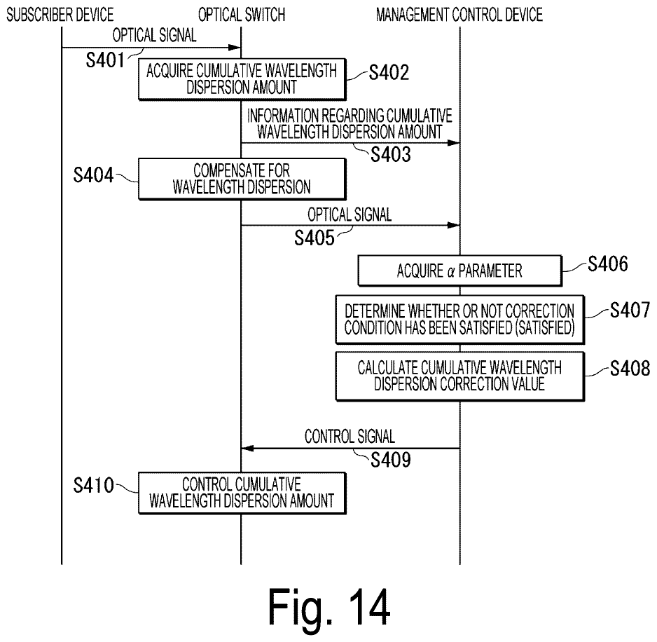

FIG. 14 is a sequence diagram illustrating a flow of processing of the optical transmission system 100c according to the fourth embodiment. Note that it is assumed that the connection relationship between input ports 311 and output ports 312 of the optical switch 30c is as illustrated in FIG. 12 in the processing in FIG. 14.

A subscriber device 10c transmits an optical signal directed to a subscriber device 20 (step S401). The optical signal transmitted from the subscriber device 10c is input to an input port 311 of the optical switch 30c via the optical transmission path. The optical signal input to the input port 311 is output from an output port 312 to which the dispersion compensation unit 40-1 is connected. Before the optical signal input to the input port 311 is output from the output port 312, the optical switch 30c acquires the optical signal and acquires transmission path information on the basis of the acquired optical signal. Note that the optical switch 30c may acquire the transmission path information on the basis of the optical signal, wavelength dispersion of which has been compensated.

The optical switch 30c acquires a cumulative wavelength dispersion amount on the basis of the acquired transmission path information and the transmission path information table 31 (step S402). The optical switch 30c notifies the management control device 50c of information regarding the acquired cumulative wavelength dispersion amount (step S403). Note that the notification of the information regarding the cumulative wavelength dispersion amount from the optical switch 30c to the management control device 50c may be performed via an electric line connecting the optical switch 30c and the management control device 50c. The control unit 53c of the management control device 50c acquires the information regarding the cumulative wavelength dispersion amount provided as a notification from the optical switch 30c.

Wavelength dispersion of the optical signal output from the output port 312 of the optical switch 30c is compensated by the dispersion compensation unit 40-1, and the optical signal is then input to an input port 311 to which the dispersion compensation unit 40-1 is connected (step S404). The optical signal input to the input port 311 to which the dispersion compensation unit 40-1 is connected is output from an output port 312 to which the subscriber device 20 is connected. The optical signal output from the output port 312 to which the subscriber device 20 is connected is branched by an optical splitter. The branched optical signal is input to the management control device 50c and the subscriber device 20 (step S405).

The α parameter measurement unit 51 of the management control device 50c acquires the α parameter by using the input optical signal, the wavelength dispersion of which has been compensated (step S406). The α parameter measurement unit 51 outputs the acquired α parameter to the control unit 53c. The control unit 53c determines whether or not the correction condition has been satisfied on the basis of the information regarding the cumulative wavelength dispersion amount, the allowable range table 52, and the α parameter (step S407). Note that it is assumed here that the correction condition is determined to have been satisfied (the problem that is attributable to the α parameter has occurred).

The control unit 53c calculates a cumulative wavelength dispersion correction value on the basis of the cumulative wavelength dispersion amount (step S408). The control unit 53c notifies the optical switch 30c of the information regarding the calculated cumulative wavelength dispersion correction value as a control signal (step S409). For example, the notification of the control signal from the management control device 50c to the optical switch 30c may be performed via an electric line.

The optical switch 30c receives the control signal provided as a notification from the management control device 50c. The dispersion compensation control unit 33 controls the cumulative wavelength dispersion amount on the basis of the cumulative wavelength dispersion correction value included in the received control signal (step S410). Specifically, the dispersion compensation control unit 33 controls the cumulative wavelength dispersion amount to reduce the cumulative wavelength dispersion amount in a case where the cumulative wavelength dispersion correction value is smaller than the current cumulative wavelength dispersion amount. For example, the dispersion compensation control unit 33 switches a path to connection to the dispersion compensation unit 40 such that the cumulative wavelength dispersion amount becomes smaller than the current amount. Note that the method of controlling the cumulative wavelength dispersion amount may be another method.

According to the optical transmission system 100c configured as described above, it is possible to curb variations in transmittable distance that are attributable to a change in α parameter. Specifically, the optical transmission system 100c includes the optical switch 30c that acquires the transmission path information on the basis of the input optical signal, the plurality of dispersion compensation units 40 that compensate for quality of the optical signal output from the optical switch 30c and input the optical signal, the quality of which has been compensated, to the optical switch 30c, the α parameter measurement unit 51 that acquires the α parameter indicating a chirp level on the basis of the optical signal, the quality of which has been compensated, and the control unit 53c that adjusts the dispersion compensation amount in a case where the condition indicating that the problem that is attributable to the α parameter has occurred is satisfied on the basis of the cumulative wavelength dispersion amount obtained on the basis of the transmission path information and the α parameter. In this manner, a detection in a case of failing to fall within a dispersion compensation range due to variations in α parameter is performed. Furthermore, the management control device 50c transmits a correction command to the optical switch 30c and causes the optical switch 30c to adjust the cumulative wavelength dispersion amount in a case where a problem is detected. It is thus possible to address a change in dispersion compensation range due to variations in α parameter. Therefore, it is possible to curb variations in transmittable distance that are attributable to a change in α parameter.

Hereinafter, a modification example of the optical transmission system 100c will be described.

The optical transmission system 100c may be modified similarly to the first embodiment.

### Fifth Embodiment

In a fifth embodiment, a configuration in which a management control device holds the transmission path information table held by the optical switch in the control method according to the fourth embodiment will be described.

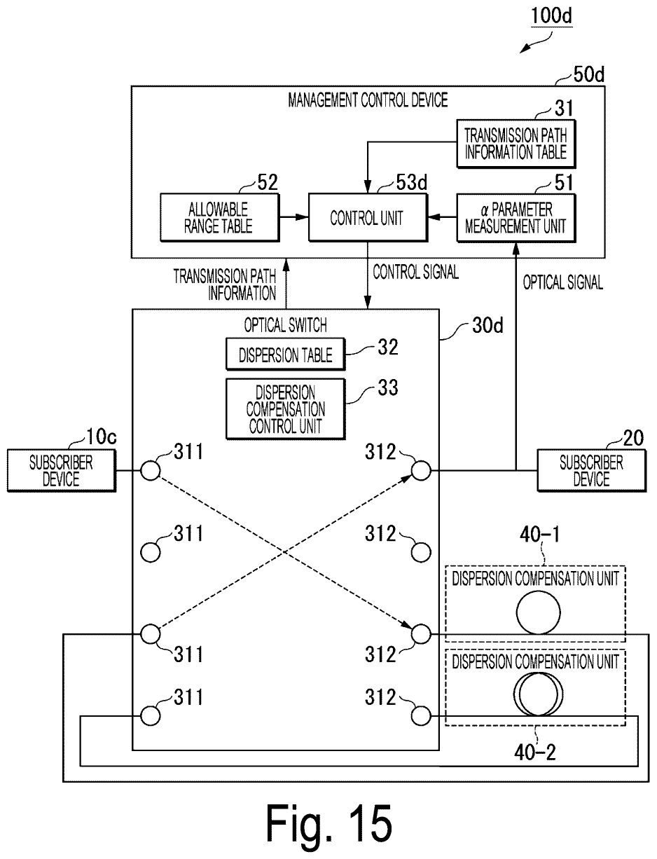

FIG. 15 is a diagram illustrating a configuration example of an optical transmission system 100d according to the fifth embodiment. The optical transmission system 100d includes one or more subscriber devices 10c, one or more subscriber devices 20, an optical switch 30d, a plurality of dispersion compensation units 40-1 and 40-2, and a management control device 50d.

The optical switch 30d has a different configuration from that of the optical switch 30c in that the optical switch 30d does not include a transmission path information table 31 and notifies the management control device 50d of transmission path information rather than information regarding a cumulative wavelength dispersion amount. In this manner, the optical switch 30d does not acquire the cumulative wavelength dispersion amount. The optical switch 30d is similar to the optical switch 30c in regard to the other configurations.

The management control device 50d has a different configuration from that of the management control device 50c in that the management control device 50d acquires the cumulative wavelength dispersion amount on the basis of transmission path information provided as a notification from the optical switch 30d. The management control device 50d includes an a parameter measurement unit 51, an allowable range table 52, a control unit 53d, and a transmission path information table 31. In this manner, the management control device 50d newly includes the transmission path information table 31, which is included by the optical switch 30c in the fourth embodiment.

The control unit 53d acquires the cumulative wavelength dispersion amount on the basis of the transmission path information table 31 and the transmission path information provided as a notification from the optical switch 30d. The control unit 53d determines whether or not a problem that is attributable to an α parameter has occurred on the basis of the acquired cumulative wavelength dispersion amount, the allowable range table 52, and the α parameter measured by the a parameter measurement unit 51. The determination regarding whether or not the problem that is attributable to the α parameter has occurred is similar to that in the first embodiment.

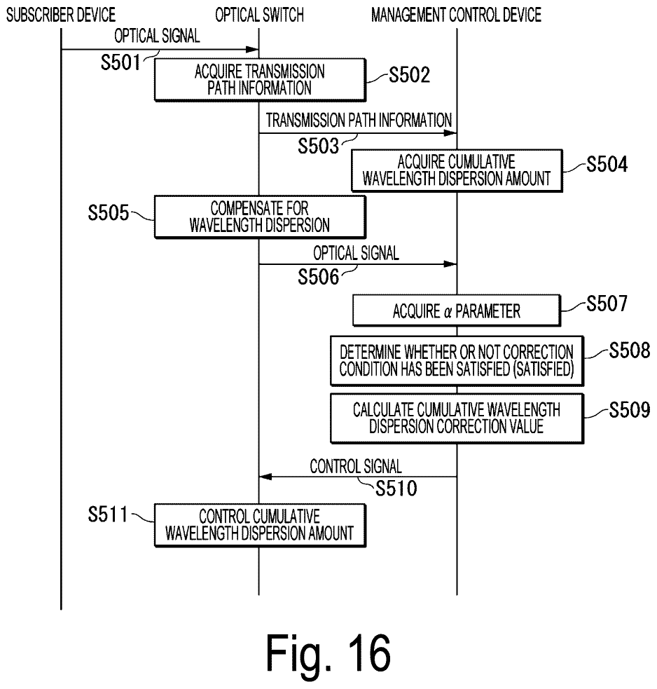

FIG. 16 is a sequence diagram illustrating a flow of processing of the optical transmission system 100d according to the fifth embodiment. Note that it is assumed that the connection relationship between input ports 311 and output ports 312 of the optical switch 30d is as illustrated in FIG. 15 in the processing in FIG. 16.

A subscriber device 10c transmits an optical signal directed to a subscriber device 20 (step S501). The optical signal transmitted from the subscriber device 10c is input to an input port 311 of the optical switch 30d via the optical transmission path. The optical signal input to the input port 311 is output from an output port 312 to which the dispersion compensation unit 40-1 is connected. Before the optical signal input to the input port 311 is output from the output port 312, the optical switch 30d acquires the optical signal and acquires transmission path information on the basis of the acquired optical signal (step S502). Note that the optical switch 30d may acquire the transmission path information on the basis of the optical signal, wavelength dispersion of which has been compensated.

The optical switch 30d notifies the management control device 50d of the acquired transmission path information (step S503). Note that the notification of the transmission path information from the optical switch 30d to the management control device 50d may be performed via an electric line connecting the optical switch 30d and the management control device 50d.

The control unit 53d of the management control device 50d acquires the transmission path information provided as a notification from the optical switch 30d. The control unit 53d acquires a cumulative wavelength dispersion amount on the basis of the acquired transmission path information and the transmission path information table 31 (step S504).

Wavelength dispersion of the optical signal output from the output port 312 of the optical switch 30d is compensated by the dispersion compensation unit 40-1, and the optical signal is then input to an input port 311 to which the dispersion compensation unit 40-1 is connected (step S505). The optical signal input to the input port 311 to which the dispersion compensation unit 40-1 is connected is output from an output port 312 to which the subscriber device 20 is connected. The optical signal output from the output port 312 to which the subscriber device 20 is connected is branched by an optical splitter. The branched optical signal is input to the management control device 50d and the subscriber device 20 (step S506).

The α parameter measurement unit 51 of the management control device 50d acquires the α parameter by using the input optical signal, the wavelength dispersion of which has been compensated (step S507). The α parameter measurement unit 51 outputs the acquired α parameter to the control unit 53d. The control unit 53d determines whether or not the correction condition has been satisfied on the basis of the acquired information regarding the cumulative wavelength dispersion amount, the allowable range table 52, and the α parameter (step S508). Note that it is assumed here that the correction condition is determined to have been satisfied (the problem that is attributable to the α parameter has occurred).

The control unit 53d calculates a cumulative wavelength dispersion correction value on the basis of the cumulative wavelength dispersion amount (step S509). Specific processing is similar to that in the fourth embodiment. The control unit 53d notifies the optical switch 30d of the information regarding the calculated cumulative wavelength dispersion correction value as a control signal (step S510). For example, the notification of the control signal from the management control device 50d to the optical switch 30d may be performed via an electric line.

The optical switch 30d receives the control signal provided as a notification from the management control device 50d. The dispersion compensation control unit 33 controls the cumulative wavelength dispersion amount on the basis of the cumulative wavelength dispersion correction value included in the received control signal (step S511). Specific processing is similar to that in the fourth embodiment.

According to the optical transmission system 100d configured as described above, effects similar to those of the fourth embodiment can be obtained.

Hereinafter, a modification example of the optical transmission system 100d will be described.

The optical transmission system 100d may be modified similarly to the first embodiment.

### Sixth Embodiment

In the fourth embodiment and the fifth embodiment, the problem that is attributable to the α parameter is detected on the basis of the cumulative wavelength dispersion amount obtained by the optical switch. In a sixth embodiment, a configuration in which the problem that is attributable to the α parameter is detected on the basis of a transmission distance will be described. Hereinafter, differences from the fifth embodiment will be described.

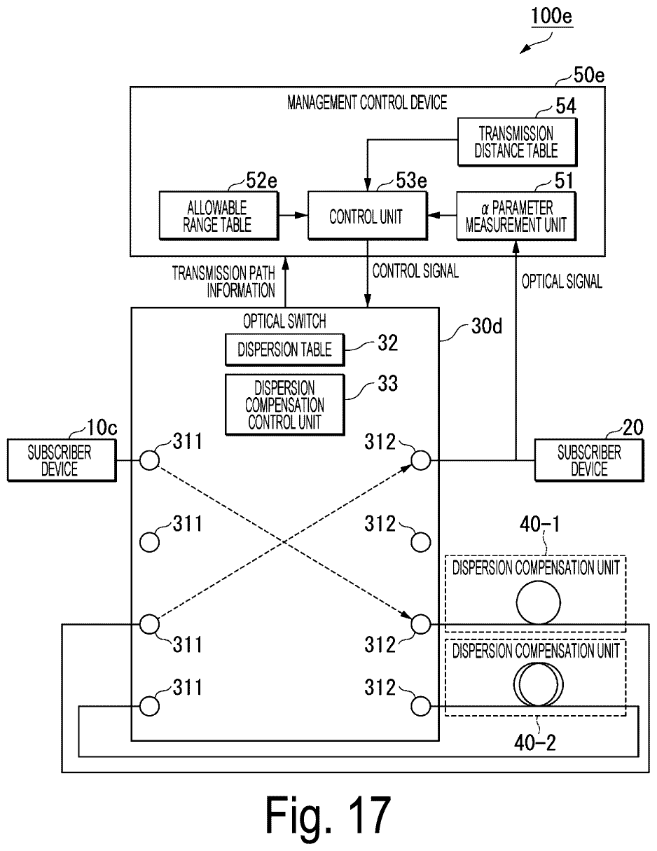

FIG. 17 is a diagram illustrating a configuration example of an optical transmission system 100e according to the sixth embodiment. The optical transmission system 100e includes one or more subscriber devices 10c, one or more subscriber devices 20, an optical switch 30d, a plurality of dispersion compensation units 40-1 and 40-2, and a management control device 50e.

The management control device 50e is different from that in the fifth embodiment in that a problem that is attributable to an α parameter is detected on the basis of a transmission distance. The management control device 50e includes an α parameter measurement unit 51, an allowable range table 52e, a control unit 53e, and a transmission distance table 54.

The allowable range table 52e is configured of a plurality of allowable range tables for each combination of a wavelength, a modulation scheme, and a transmission rate. The allowable range table 52e is similar to the allowable range table 52b in the third embodiment.

The control unit 53e determines whether or not a problem that is attributable to the a parameter has occurred on the basis of the allowable range table 52e, the α parameter measured by the α parameter measurement unit 51, the transmission path information provided as a notification from the optical switch 30d, and the transmission distance table 54.

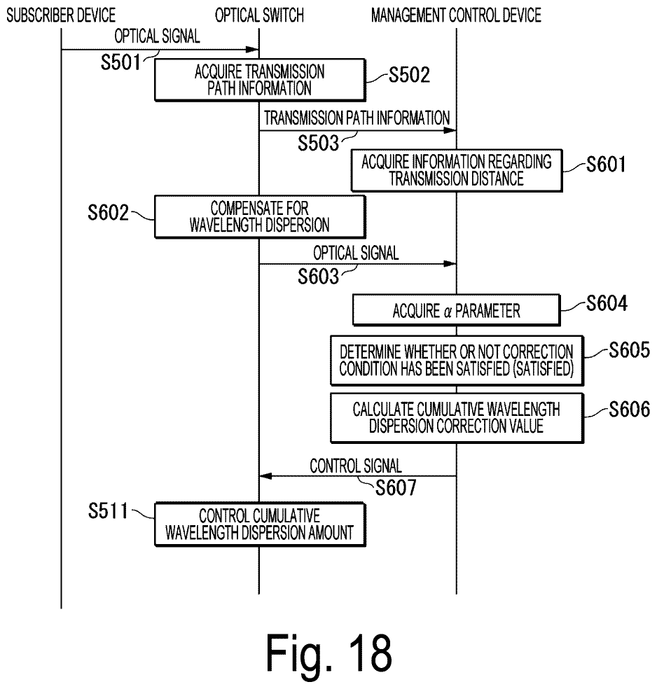

FIG. 18 is a sequence diagram illustrating a flow of processing of the optical transmission system 100e according to the sixth embodiment. Note that it is assumed that the connection relationship between input ports 311 and output ports 312 of the optical switch 30d is as illustrated in FIG. 17 in the processing in FIG. 18. In FIG. 18, the same processing as that in FIG. 16 will be denoted by the same reference sign as that in FIG. 16, and description thereof will be omitted.

After the processing in step S201 to step S203 ends, the control unit 53e of the management control device 50e acquires the transmission path information provided as a notification from the optical switch 30d. The control unit 53e acquires information regarding the transmission distance on the basis of the acquired transmission path information and the transmission distance table 54 (step S601). Specifically, the control unit 53e acquires information regarding the transmission source and information regarding the transmission destination included in the acquired transmission path information. The control unit 53e refers to the transmission distance table 54 and acquires information regarding the transmission distance corresponding to the acquired combination of the information regarding the transmission source and the information regarding the transmission destination.

Wavelength dispersion of the optical signal output from the output port 312 of the optical switch 30d is compensated by the dispersion compensation unit 40-1, and the optical signal is then input to an input port 311 to which the dispersion compensation unit 40-1 is connected (step S602). The optical signal input to the input port 311 to which the dispersion compensation unit 40-1 is connected is output from an output port 312 to which the subscriber device 20 is connected. The optical signal output from the output port 312 to which the subscriber device 20 is connected is branched by an optical splitter. The branched optical signal is input to the management control device 50e and the subscriber device 20 (step S603).

The α parameter measurement unit 51 of the management control device 50e acquires the α parameter by using the input optical signal, the wavelength dispersion of which has been compensated (step S604). The α parameter measurement unit 51 outputs the acquired α parameter to the control unit 53e. The control unit 53e determines whether or not the correction condition has been satisfied on the basis of the acquired information regarding the transmission distance, the allowable range table 52e, and the α parameter (step S605). Specific processing is similar to that in the third embodiment. Note that it is assumed here that the correction condition is determined to have been satisfied (the problem that is attributable to the α parameter has occurred).

The control unit 53e calculates a cumulative wavelength dispersion correction value on the basis of the transmission distance (step S606). The control unit 53e notifies the optical switch 30d of the information regarding the calculated cumulative wavelength dispersion correction value as a control signal (step S607). For example, the notification of the control signal from the management control device 50e to the optical switch 30d may be performed via an electric line. Thereafter, processing in step S511 is executed.

According to the optical transmission system 100e configured as described above, the management control device 50e determines whether or not the problem that is attributable to the α parameter has occurred on the basis of the transmission distance acquired on the basis of the transmission path information and the α parameter. In this manner, the management control device 50e can detect the problem that is attributable to the α parameter on the basis of the transmission distance unlike the fourth embodiment and the fifth embodiment. Furthermore, the control unit 53e causes the optical switch 30d to adjust the cumulative wavelength dispersion amount in a case where the condition indicating that the problem that is attributable to the parameter α has occurred is satisfied. In this manner, in a case where the problem is detected, the management control device 50e transmits a correction command to the optical switch 30d, and the optical switch 30d adjusts the cumulative wavelength dispersion amount. It is thus possible to address a change in dispersion compensation range due to variations in α parameter. Therefore, it is possible to curb variations in transmittable distance that are attributable to a change in α parameter.

Hereinafter, a modification example of the optical transmission system 100e will be described.

The optical transmission system 100e may be modified similarly to the third embodiment.

Some functional units of the optical switches 30, 30a, 30c, and 30e and the management control devices 50, 50a, 50b, 50c, 50d, and 50e in the aforementioned embodiments may be realized by a computer. In that case, a program for realizing the functions may be recorded in a computer-readable recording medium, and the functions may be realized by causing a computer system to read and execute the program recorded in the recording medium. Note that the “computer system” mentioned herein includes an OS and hardware such as peripheral devices.

Also, the “computer-readable recording medium” is a portable medium such as a flexible disk, a magneto-optical disc, a ROM, or a CD-ROM, or a storage device such as a hard disk embedded in the computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. Also, the foregoing program may be for implementing some of the functions described above, may be implemented in a combination of the functions described above and a program already recorded in a computer system, or may be implemented with a programmable logic device such as an FPGA.

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention can be applied to an optical transmission system.

### REFERENCE SIGNS LIST

10, 10c, 20 Subscriber device
30, 30a, 30c, 30e Optical switch
31 Transmission path information table
32 Dispersion table
33 Dispersion compensation control unit
40, 40-1 to 40-2 Dispersion compensation unit
50, 50a, 50b, 50c, 50d, 50e Management control device
51 α parameter measurement unit
52, 52b, 52e Allowable range table
53, 53a, 53b, 53c, 53d, 53e Control unit
54 Transmission distance table

1. An optical transmission system comprising:
an optical switch configured to include a plurality of ports, outputs an optical signal input from any one of the ports from a different one of the ports, and acquires transmission path information on the basis of the optical signal input to the port;
a plurality of dispersion compensators configured to compensate for quality of the optical signal output from the optical switch and input the optical signal with the compensated quality to the optical switch;
an α parameter measurer configured to acquire an α parameter indicating a chirp level on the basis of the optical signal with the compensated quality; and
a controller configured to perform correction of the α parameter or adjustment of a dispersion compensation amount in a case where a condition indicating that a problem that is attributable to the α parameter has occurred is satisfied on the basis of a cumulative wavelength dispersion amount or a transmission distance obtained on the basis of the transmission path information and the α parameter.

2. The optical transmission system according to claim 1,
wherein the optical switch calculates the cumulative wavelength dispersion amount or the transmission distance on the basis of the transmission path information, and
the controller determines that the condition indicating that the problem that is attributable to the α parameter has occurred is satisfied in a case where the cumulative wavelength dispersion amount or the transmission distance calculated by the optical switch is outside an allowable range obtained on the basis of the α parameter.

3. The optical transmission system according to claim 1,
wherein the optical switch notifies the controller of the transmission path information, and
the controller calculates the cumulative wavelength dispersion amount or the transmission distance on the basis of the transmission path information provided as a notification from the optical switch, and in a case where the calculated cumulative wavelength dispersion amount or transmission distance is outside an allowable range obtained on the basis of the α parameter, the controller determines that the condition indicating that the problem that is attributable to the α parameter has occurred is satisfied.

4. The optical transmission system according to claim 1,
wherein in a case where it is determined that the condition indicating that the problem that is attributable to the α parameter has occurred is satisfied, the controller unit notifies a subscriber device, which is a transmission source of the optical signal, of an α parameter correction value for correcting an α parameter of the subscriber device via the optical switch.

5. The optical transmission system according to claim 1,
wherein the optical switch further includes a dispersion compensation controller that changes a cumulative wavelength dispersion amount of a transmission path,
the controller notifies the optical switch of a cumulative wavelength dispersion correction value for causing the optical switch to change the cumulative wavelength dispersion amount in a case where it is determined that the condition indicating that the problem that is attributable to the α parameter has occurred is satisfied, and
the dispersion compensation controller changes the cumulative wavelength dispersion amount of the transmission path on the basis of the cumulative wavelength dispersion correction value provided as a notification from the controller.

6. The optical transmission system according to claim 1,
wherein the controller further determines that the condition indicating that the problem that is attributable to the α parameter has occurred is satisfied in a case where the cumulative wavelength dispersion amount or the transmission distance calculated by the optical switch is outside a threshold value within a prescribed allowable range.

7. An adjustment method comprising:
by an optical switch including a plurality of ports, outputting an optical signal input from any one of the ports from a different one of the ports and acquiring transmission path information on the basis of the optical signal input from the port;
compensating for quality of the optical signal output from the optical switch and inputting the optical signal with the compensated quality to the optical switch;
acquiring an α parameter indicating a chirp level on the basis of the optical signal with the compensated quality; and
performing correction of the α parameter or adjustment of a dispersion compensation amount in a case where a condition indicating that a problem that is attributable to the α parameter has occurred is satisfied on the basis of a cumulative wavelength dispersion amount or a transmission distance obtained on the basis of the transmission path information and the α parameter.
